(19) United States
(12) Patent Application Publication
(10) Pub. No.: US 2013/0209687 A1
(43) Pub. Date: Aug. 15, 2013

(54) ADHESION PROMOTING PROCESS FOR PAINTING PLASTIC PARTS

(71) Applicants: Charles K. Buehler, Lansing, MI (US); Stuart J. Brown, Flint, MI (US)

(72) Inventors: Charles K. Buehler, Lansing, MI (US); Stuart J. Brown, Flint, MI (US)

(73) Assignee: GM GLOBAL TECHNOLOGY OPERATIONS LLC, Detroit, MI (US)

(21) Appl. No.: 13/371,296

(22) Filed: Feb. 10, 2012

(51) Int. Cl. B05D 3/04; B05D 3/10; B05D 3/00

(52) U.S. Cl. 427/296; 427/301

(57) ABSTRACT

A process for treating a plastic part to improve the adhesion of paint comprises first treating the surface of the part with sulfur trioxide and thereafter treating the surface with ammonium.

### FIELD OF THE INVENTION

The present invention relates to improving the adhesion of paint on molded plastic panels used in motor vehicle exteriors.

### BACKGROUND OF THE INVENTION

Exterior plastic panels for motor vehicles are often molded of plastic such as thermoplastic polyolefin (TPO). Plastic panels are advantageous for durability, competitive cost and design flexibility including complex shapes with tight radii.

Although highly desirable, TPO and other plastic panels present difficulties in achieving a high quality painted surface that is necessary on motor vehicle exterior panels such as fenders, hoods, and bumper fascias. In particular, it is difficult to achieve proper adhesion of the paint to the TPO surface, particularly at the location of tight radii.

In general, plastic panels will not paint properly because the paint has polar content, and the surface of the plastic panel is non-polar, thus being incompatible. The surface of the plastic panel does not wet sufficiently. Plastic materials experiencing this problem are the hydrocarbon based polymers that contain primary, secondary or tertiary carbons with hydrogen molecules attached. Examples are polypropylene (PP), polyethylene (HDPE, LLDPE, and LDPE, thermoplastic olefin (TPO), polybutene (PB) and others.

The prior art has discussed various techniques for enhancing the adhesion of the paint. For example, a commonly used process, typically known as an Adhesion Promoter, involves the use of a soap-like compatiblizer that absorbs into the surface of the plastic panel, thus enhancing the ability of the paint to adhere.

Another method to improve adhesion involves flame treating of the TPO surface to create carbon oxygen bonds, followed by coating with a primer. However, the treated surface must be painted within a short period of time, typically within an hour.

Accordingly, it would be desirable to provide a new and improved process for enhancing the paintability of molded plastic vehicle exterior parts.

### SUMMARY OF THE INVENTION

A process for treating a plastic part to improve the adhesion of paint comprises first treating the surface of the part with sulfur trioxide and thereafter treating the surface with ammonium.

Further areas of applicability of the present invention will become apparent from the detailed description provided hereinafter. It should be understood that the detailed description and specific examples, while indicating exemplary embodiments of the invention, are intended for purposes of illustration only and do not limit the scope of the invention.

### DETAILED DESCRIPTION OF THE EXEMPLARY EMBODIMENTS

The following description of certain exemplary embodiments is merely exemplary in nature and is not intended to limit the invention, its application, or uses.

We have discovered that a process incorporating sulfur trioxide (SO3) pretreatment of plastic parts in a moisture free environment, followed by neutralization with a common base NH4 will provide a polar group formation on the surface of the plastic panel, and once neutralized, the attached surface treated group (S03-NH4+) is stable and the treated parts can be stored indefinitely before priming and painting. The treated surface enhances paint adhesion and enables part designs with radii of less than 2.0 mm.

We have found that S03 is ultra-reactive to compounds containing hydrogen molecules or protons, and will react instantaneously with primary, secondary and tertiary hydrogen's that are common in the non-polar polymeric surface of the plastic part. But, unfortunately, S03 also reacts with water to form sulfuric acid. We have found that to get the preferential reactions to take place, the S03 must be presented to the preferred reaction site in a moisture free atmosphere of dry air or other inert gas, followed by capping the reactive S03 with NH4 or ammonium. This stabilizes the S03 indefinitely to create a functional group on the surface bonded chemically to the surface of the TPO substrate. This covalent bond creates strong adhesion of the paint to the substrate, since paints have non-polar functionality.

The following examples are presented solely to illustrate the process and should not be construed as a limitation on the scope of the claimed invention.

### EXAMPLE 1

The S03 is generated by catalytically oxidizing S02 to S03 across a vanadium catalyst at about 454 C (850 F). The S03 is stored in a very dry vessel and metered into a stream of very dry air or inert gas with a moisture reading equal to, or less than −60 C via a Panametrics moisture analyzer.

The molded TPO parts are placed in a vacuum chamber where air is evacuated down to 30 inches of mercury. Fresh dry air or dry inert gas is then added to the evacuated chamber. This process of evacuating and then adding the dry air or dry inert gas can be done from one to four times to remove all moisture from the chamber and from the part.

When the drying is completed, a metered amount of S03 mixed with dry air or inert gas is applied to the plastic part. The SO3 can be introduced following the final evacuation of the chamber. Or the dry air or inert gas within the chamber can replaced by flowing a stream of the SO3 laden dry air or inert gas through the chamber.

The S03 reaction is instantaneous because it reacts with hydrogen molecules attached to tertiary, secondary, or primary carbons in that order. This reaction occurs effectively at room temperature. However the reaction can be done at reduced temperatures and or elevated temperatures to control reaction rate.

Ammonium (NH4) is then added to neutralize any active S03-H molecule not reacted and to form stable S03-Nh4+ with excess NH4 remaining unreacted. Any unreacted NH4 is collected to be used over in treating additional parts, or processed as a by-product for use as a fertilizer.

### EXAMPLE 2

An alternate method of application is to dry the TPO plastic parts in hot dry air, and then envelope the part in very dry air. While the part is enveloped in dry air, the S03 is added for reaction. After a specified time, ammonium gas is metered into the dry air stream to neutralize and cap the reacted SO3. Finally, the part is dried. dried.

The process of Example 2 can be conducted in either a batch process or a continuous process, with hot air or inert gas at 125 C (275 F) air or, or in an oven.

The batch process can be conducted in a sealed chamber. The continuous process can be conducted as the parts are conveyed through a cylinder shaped tunnel with a conveying belt at the bottom of the tunnel. Gas inlet ports are provided at specific locations along the top of the tunnel and gas outlet ports are provided at the bottom. When the part first enters, dry hot air or dry inert gas is metered in at a specific velocity to displace moist air, and the entire part is enveloped for a specific time. The air exits the tunnel around the conveyer belt, via a vacuum line that helps direct air flow, and carries away the moisture. At a specific point, the dry air velocity is lowered and metered S03 is added and allowed to react with surface of part. After reaction, the dry air/S03 gas mixture is directed away from part to a neutralization tank to contain any sulfuric acid, produced as byproduct of S03 with any residual moisture. After S03 reaction, ammonium is metered into dry air to cap the active S03 on the surface of the part. Then, the exiting gas mixture of ammonium dry air is passed through a waste treatment area or concentrator where ammonium converted to ammonium salt is collected for use as nitrogen fertilizer.

We have found that the SO3 content of the treated surface should be in the range of about 0.064 g/m2 to 0.071 g/m2. The quality of the process is monitored by analyzing the treated surface for sulfur content.

What is claimed is:

1. A process for treating a plastic part to improve the adhesion of paint, comprising:
treating the surface of the part with sulfur trioxide;
and thereafter treating the surface with ammonium.

2. The process of claim 1 further comprising drying the part prior to treating the part with sulfur trioxide and treating the surface of the part with sulfur trioxide in a moisture-free environment.

3. The process of claim 1 further comprising placing the parts in a vacuum chamber, evacuating air from the chamber, then adding fresh dry air or inert gas, and then again evacuating the chamber again to dry the part and create a moisture free environment.

4. The process of claim 3 further comprising, after evacuating the air, adding the sulfur trioxide to dry air or inert gas and introducing the mixture of sulfur trioxide and dry air or inert gas into the evacuated chamber to treat the surface of the part with sulfur trioxide.

5. The process of claim 1 further comprising drying the part by flowing heated air across the part, treating the surface of the part with sulfur trioxide by flowing a mixture of sulfur trioxide and dry air or inert gas across the part, and thereafter treating the surface of the part with ammonium by flowing a mixture of ammonium and dry air across the part to treat the surface of the part with sulfur trioxide.

6. The process of claim 1 further comprising generating the sulfur trioxide by catalytically oxidizing sulfur dioxide to sulfur trioxide across a vanadium catalyst at about 850 F.

7. The process of claim 1 further comprising storing the sulfur trioxide in a very dry vessel and metering the sulfur trioxide into a stream of very dry air or inert gas with a moisture reading equal to, or less than −60 C as mearured by a Panametrics moisture analyzer.

8. The process of claim 1 further comprising generating the sufur trioxide by catalytically oxidizing sulfur dioxide to sulfur trioxide across a vanadium catalyst at about 850 F, storing the sulfur trioxide in a very dry vessel, metering the sulfur trioxide into a stream of very dry air or inert gas with a moisture reading equal to, or less than −60 C as measured by a Panametrics moisture analyzer, and flowing the stream of very dry air or inert gas across the part.

9. The process of claim 1 further comprising obtaining an sulfur trioxide content of the treated surface in the range of about 0.064 g/m2 to 0.071 g/m2.

10. The process of claim 1 further comprising analyzing the treated surface for reaction completeness by analyzing for the undesirable presence of sulfur, indicating that water was present and sulfuric acid was produced.

11. A process for treating a plastic part to improve the adhesion of paint, comprising:
placing the parts in a vacuum chamber, evacuating air from the chamber, then adding fresh dry air or inert gas, and then again evacuating the chamber again to dry the part and create a moisture free environment;
after evacuating the chamber, adding sulfur trioxide to dry air or inert gas and introducing the mixture of sulfur trioxide and dry air or inert gas into the evacuated chamber to treat the surface of the part with sulfur trioxide;
and thereafter treating the surface of the part with ammonium by introducing a mixture of ammonium and dry air or inert gas into the chamber to cap the sulfur trioxide with ammonium.

12. The process of claim 11 further comprising generating the sulfur trioxide by catalytically oxidizing sulfur dioxide to sulfur trioxide across a vanadium catalyst at about 850 F.

13. The process of claim 11 further comprising storing the sulfur trioxide in a very dry vessel and metering the sulfur trioxide into a stream of very dry air or inert gas with a moisture reading equal to, or less than −60 C as mearured by a Panametrics moisture analyzer.

14. The process of claim 11 further comprising generating the sufur trioxide by catalytically oxidizing sulfur dioxide to sulfur trioxide across a vanadium catalyst at about 850 F, storing the sulfur trioxide in a very dry vessel, metering the sulfur trioxide into a stream of very dry air or inert gas with a moisture reading equal to, or less than −60 C as measured by a Panametrics moisture analyzer, and flowing the stream of very dry air or inert gas across the part.

15. The process of claim 11 further comprising obtaining an sulfur trioxide content of the treated surface in the range of about 0.064 g/m2 to 0.071 g/m2.

16. A process for treating a plastic part to improve the adhesion of paint, comprising:
drying the part in a flow of hot air;
making a mixture of sulfur trioxide and dry air or inert gas and flowing the mixture about the part to treat the surface of the part with sulfur trioxide;
making a mixture of ammonium and dry air or inert gas and flowing the mixture about the part to cap the sulfur trioxide with ammonium.

17. The process of claim 16 further comprising generating the sulfur trioxide by catalytically oxidizing sulfur dioxide to sulfur trioxide across a vanadium catalyst at about 850 F.

18. The process of claim 16 further comprising storing the sulfur trioxide in a very dry vessel and metering the sulfur trioxide into a stream of very dry air or inert gas with a moisture reading equal to, or less than −60 C as mearured by a Panametrics moisture analyzer.

19. The process of claim 16 further comprising generating the sufur trioxide by catalytically oxidizing sulfur dioxide to sulfur trioxide across a vanadium catalyst at about 850 F, storing the sulfur trioxide in a very dry vessel, metering the sulfur trioxide into a stream of very dry air or inert gas with a moisture reading equal to, or less than −60 C as measured by a Panametrics moisture analyzer, and flowing the stream of very dry air or inert gas across the part.

20. The process of claim 16 further comprising obtaining an sulfur trioxide content of the treated surface in the range of about 0.064 g/m2 to 0.071 g/m2.
